(19) United States
(12) Patent Application Publication
(10) Pub. No.: US 2014/0126999 A1
(43) Pub. Date: May 8, 2014

(54) High Efficiency Hydro-mechanical Vehicle Transmission

(71) Applicant: Robert Hugh Francis Lloyd, Los Altos, CA (US)

(72) Inventor: Robert Hugh Francis Lloyd, Los Altos, CA (US)

(21) Appl. No.: 13/670,443

(22) Filed: Nov. 6, 2012

(51) Int. Cl. F16D 1/02

(52) U.S. Cl. CPC F16D 1/02
USPC 415/122.1

(57) ABSTRACT

A vehicle transmission consisting of two or more fixed displacement hydraulic pumps mounted on a common shaft (input) which provide the fluid to drive one or more fixed displacement hydraulic motors on a second common shaft (output) and a means of selectively activating and deactivating the pumps and motors to change the rotational speed of the second shaft with respect to the first shaft. The two shafts are connected by a selectable one way clutch to allow the hydraulic elements to be bypassed under certain operating conditions. Variations include the use of a reduction gear driving the input shaft and a two or more speed mechanical transmission on the output shaft. A hydraulic reservoir and accumulator are provided for energy storage and to accomplish instantaneous torque control. When used to provide hydraulic regenerative braking, the roles of pumps and motors are reversed.

This application is a Continuation Application that claims the benefits of co-pending Non-Provisional application Ser. No. 12/728,268 filed Mar. 21, 2010 and entitled “INFINITELY-VARIABLE, HYDRO-MECHANICAL TRANSMISSION USING FIXED DISPLACEMENT PUMPS AND MOTORS ” and Non-Provisional application Ser. No. 13/429,179 filed Mar. 23, 2012 entitled “ ENHANCEMENTS TO A HYDRO-MECHANICAL TRANSMISSION BASED ON FIXED DISPLACEMENT PUMPS AND MOTORS” and Provisional Application No. 61/619,250 filed Apr. 2, 2012 entitled “TRANSMISSION CONSISTING OF HYDRO-MECHANICAL TRANSMISSION AND A CONVENTIONAL TRANSMISSION”.

### TECHNICAL FIELD

The present invention relates to a power transmitting transmission consisting of both a hydraulic transmission and various mechanical enhancements intended primarily for road vehicles. By avoiding the use of variable displacement hydraulic pump/motors, the transmission features high efficiency and low cost and can be built to fit in the same space as used by conventional manual and automatic transmissions. By the use of a selectable one-way clutch, the hydraulic portion of the transmission is completely bypassed when the vehicle reaches cruising speed. The transmission has the ability to be shifted very rapidly and exhibits no “torque gap”. The transmission contains all the elements necessary to implement hydraulic regenerative braking except the accumulator and reservoir.

### BACKGROUND OF THE INVENTION

All present hydraulic transmission intended for vehicles are based on variable displacement hydraulic devices. None of them have been successfully applied to road vehicles due to problems associated with the variable displacement devices. These problems relate to efficiency, cost, form factor, noise and reliability.

### SUMMARY OF THE INVENTION

1, When driving the vehicle in forward, the basic transmission consists of two or more hydraulic pumps on a common (input) shaft driving one or more hydraulic motors on a common (output) shaft. The transfer ratio of the transmission (gear) is set by selection of one or more of the input pumps to supply one or more of the output motors. This ratio is determined by dividing the total fluid flow in the selected output motors times their average displacement per revolution by the total flow in the selected input pumps times their average displacement per revolution. Reverse gear is accomplished by reversing the flow direction in the output motors.

2, When not selected, a valve located close to each pump/motor causes the fluid to be re-circulated thru the pump/motor. Since the re-circulation path is short, the power losses due to the re-circulating fluid are low thereby allowing for a high efficiency transmission.

3, To achieve high efficiency and low wear while cruising, a provision is made for the hydraulic transmission to be by-passed by an all mechanical path implemented with a selectable, one-way clutch. The use of the one-way clutch allows for the seamless transition to regenerative braking when braking and/or decelerating.

4, The use of gear type pump/motors allows for a coaxial construction which results in a physical size and shape that can fit in the same space as a conventional transmission.

5, A reduction gear is provided for on the input shaft so that the input pump/motors can supply more torque to the output pump motors and can operate at a lower rpm that the power source motor. (Many pump/motors can not operate reliable at the high rpm typical of internal combustion engines (ICE))

6, To compensate for the usual poor performance as motors at low rpm of high efficiency pumps, motors with good performance at low rpm are added to both the input and the output of the transmission.

7, An accumulator and reservoir can be added to the transmission to allow very rapid shifting, starting of the internal combustion engine with hydraulic power (so the ICE can stop every time the vehicle stops) and the implementation of hydraulic regenerative braking.

8, The controlled fluid flow into and out of the accumulator can be used to adjust the transfer ratio thereby resulting in a continuously variable transmission.

9, The flow into and out of the accumulator is in many cases controlled by the output torque of the transmission. In some cases this is as requested by the vehicle operator or to absorb pressure spikes caused by rapid shifting.

10 The use of a one-way clutch also allows the use of both input and output pump/motors for maximum torque during initial acceleration of the vehicle. The input dog clutch would be dis-engaged in this case.

11, The dog clutch on the input also allows high efficiency continuously variable regenerative braking by locating a variable flow valve in the re-circulating path of one of the unselected input pump/motors. The pressure drop across this flow restricting valve will cause the associated motor to turn the input shaft thereby driving the selected input pump/motors as pumps causing additional fluid to be pump into the accumulator thereby increasing the braking torque in a continuously variable manner.

12, A mechanical transmission can be attached to the output of the transmission to providing a convenient means of increasing the number of useable transfer ratios.

13, An electric motor/generator can be placed on the input shaft after the dog clutch to allow the transmission to add hydraulic regenerative braking to a plug-in electric hybrid or all-electric vehicle.

14, Both the pump/motors in the input and the output can serve as brakes if a controllable flow restrictor is placed in the recirculation path of any un-selected pump/motors.

15, The displacement of the input and output pump/motors and the input reduction gear are selected so that in one case the input and output shaft will be at the same rpm, thereby assisting in the synchronization required before engaging the one-way clutch.

16, A accelerometer trigger safety valve can be placed on the accumulator to allow its pressure be reduced by allowing fluid flow to the reservoir in the event of a vehicle crash.

### BRIEF DESCRIPTION OF THE DRAWINGS

FIG. 1 is a diagram of the basic hydraulic transmission according to the invention.

FIG. 2 illustrates the various additions to and features of the hydro-mechanical transmission according to the invention.

FIG. 3 is a cross section representation of one of the possible transmission configurations.

FIG. 4 illustrates the case where an electric motor/generator is added to the transmission to allow it to serve an electric plug-in hybrid with hydraulic regenerative braking.

### DESCRIPTION OF THE PREFERED EMBODIMENTS

In this description, the term pump/motor refers to hydraulic devices that can function either as a hydraulic pump or hydraulic motor. The pump/motors attached to the output shaft can function thus for liquid flows in either direction whereas the devices attached to the input shaft need only function for flows in a single direction.

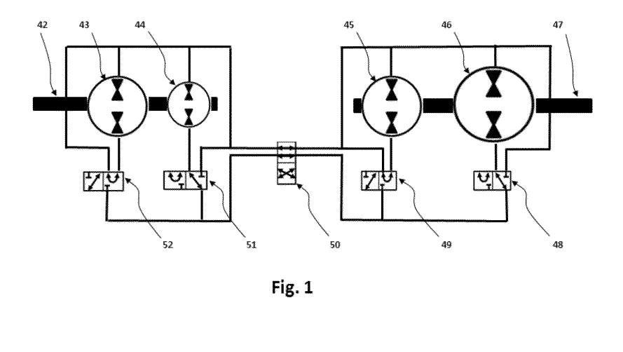

There is shown in FIG. 1 the elements of the basic hydraulic transmission that is the basis of this invention. It consists of two or more input pump/motors and one or more output pump/motors. In this case, input pump/motors 43 and 44 are permanently attached to input shaft 42 and pump/motors 45 & 46 are permanently attached to output shaft 47. Control valves 48, 49, 51 & 52 have two positions one allowing the device to function as a pump or a motor or de-activating the device by causing the fluid to simple circulate within the pump/motor. When in forward gear, pump/motors 43 & 44 would be driven as pumps by a power source such as an internal combustion engine. The fluid would be pumped into pump/motors 45 & 46 acting as motors to drive output shaft 47. The flow per revolution of the input shaft 42 would be determined by which of the input pumps are activated. The rotational speed of the output shaft 42 would be determined by the flow from the input pumps divided by the total displacement per revolution of the selected output motors 45 & 46. Thereby the ratio of the output rpm to the input rpm can be changed by selecting various combinations of input and output pump/motors. The valve 50 allows the direction of the output shaft to be reversed for the same rotational direction of the input shaft (as when the vehicle is in reverse).

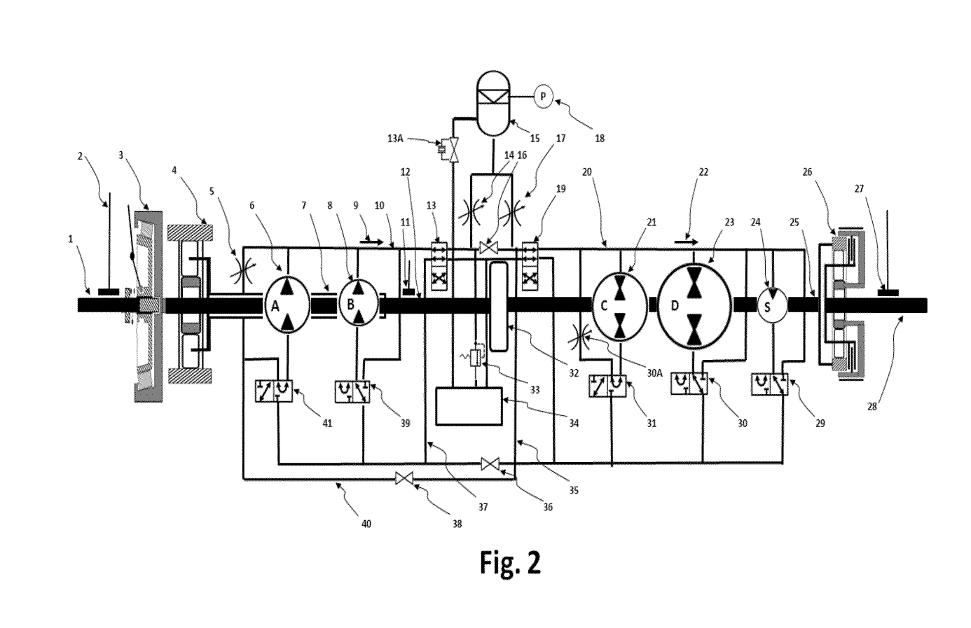

The various enhancements that are part of this invention are illustrated in FIG. 2.

Valves 29, 30, 31, 39, & 41 are located physically as close of possible to their respective pump/motors to minimize power loss when rotating by not selected.

Item 2 is a device to measure the rpm of the input shaft 1. Item 3 is a dog clutch that separates the input shaft from the rest of the transmission. Item 4 is a reduction gear that reduces the rotational speed of cylindrical shaft 7 from the rotational speed of the input shaft 1. The use of the reduction gear results in a reduction of the maximum rotational speed required of the input pump/motors, and larger displacement input pump/motors being required to maintain the same transfer ratio. This results in a higher torque capability when in the hydraulic transmission mode. The fixed displacement input pump/motors 6 & 8 are concentrically fixed to cylindrical shaft 7 which is concentric with shaft 12. Item 11 is a transducer to measure the rpm of shaft 12. Shaft 12 is connected to the intermediate output shaft 25 by the one-way clutch 32. Items 21, 23, & 24 are fixed displacement pump/motors permanently attached to shaft 25 in a concentric manner. Item 24 is a hydraulic motor optimized for relatively high torque at very low rpm. Item 26 is a conventional mechanical transmission connecting shaft 25 to the output shaft 28. Item 27 is a device that measures both output torque and rpm of shaft 28. Item 15 is a hydraulic accumulator and 18 is a pressure transducer. The soft start function normally supplied by the torque converter can be accomplished by diverting some of the start-up flow from pump/motors 6 & 7 into the accumulator 15. This fluid would be sourced from reservoir 34 and the amount of flow determined by flow constraining valve 18 controlled in turn by a signal from the output torque transducer 27 the amount of torque requested by the operator. Valve 16 would be open in this case to allow some of the fluid to drive pump/motors 21, 23 & 24. This in effect changes the transfer ratio of the transmission on a continuous basis. Depending on the pressure in the accumulator 15 relative to the fluid pressure being delivered by the input pump/motors 6 and/or 8 this diversion will decrease or increase the transfer ratio of the transmission. Any ratio can be achieved by either shifting to a higher ratio than desired and reducing it with the diversion (in the case when the fluid pressure in the accumulator is lower than that produced by pump/motor 6 and/or 8 or in the case when the pressure in the accumulator is higher than that produced by the input pump/motors, shifting it to a lower ratio than desired and increasing to the desired level with the additional flow from the accumulator. Through these two conditions any transfer ratio can be realized thus resulting in a continuously variable transmission. The measurement of the output rpm with transducer 27 would one of the inputs to control this process.

Item 13A is a safety release valve controlled by an omni-directional accelerometer that will cause the valve to open when the accumulator receives a shock from any direction thereby reducing its pressure by causing the fluid to flow into the reservoir 34. Should no damage be experienced from the crash, the valve can be closed and the accumulator recharged. Items 14, 17 and 5 are variable flow restricting valves. Items 16, 36, & 38 are on/off fluid control valves. Items 13 & 19 are flow reversing valves. Valves 29, 30, 31, 39, & 41 are valves that are used to select the associated pump/motors or put them into the re-circulating or un-selected mode. As shown, input pump/motors 8 and output pump/motors 23 & 24 are selected. 33 is an over pressure relief valve that exhausts fluid into the reservoir 34 in the case of excessive pressure.

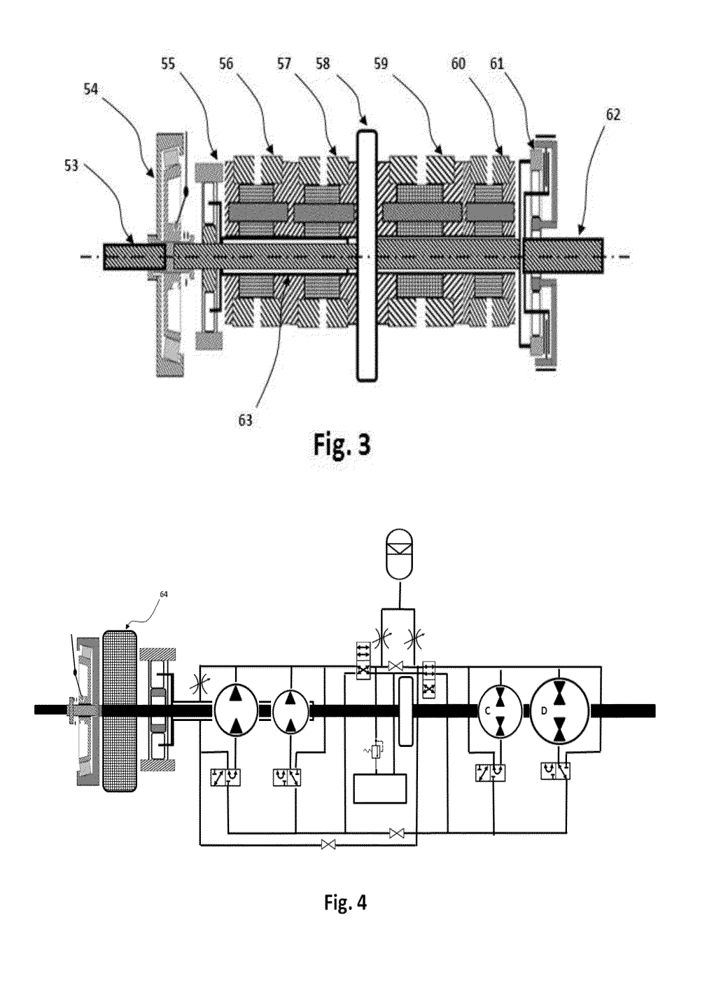

FIG. 3 is a cross-section representation of one way that the transmission could be mechanically packaged. The input shaft 53 connects to the dog clutch 54. 55 is the gear that reduces the revolutionary speed of input pump/motors 56 & 57 which are concentrically fixed to hollow shaft 63. The selectable one-way clutch 58 connects the shaft from the dog clutch to the shaft upon which output pump/motors 59 & 60. This shaft in turn is connected to the planetary gear transmission 61 which in turn is connected to the output shaft 62.

FIG. 4 illustrates the case where the transmission can be used to add hydraulic regenerative braking to an electric or hybrid electric vehicle by attaching an electric motor/generator to the input shaft as shown.

### Operation (Referring to FIG. 2)

1^{st} gear (assuming no accumulator 15 or reservoir 34)

Valve arrangement:
Valve 5 is full open.
Valves 16 & 36 are closed.
Valve 38 is open.
Valves 13 & 19 are in the positions shown in FIG. 2 assuming that the displacement of pump/motor 8 is less than pump/motor 6.
Valves 29, 30, 39, & 41 are in the positions shown in FIG. 2. Valve 31 is changed to the same position as valve 30.
Valve 30A is open.

The fluid flows would be as shown by 9 and 22.

With this arrangement we have the minimum displacement input pump driving the maximum displacement output motors resulting in the maximum number of input shaft rotations for each output shaft rotation i.e. 1^{st} gear.

Some pumps don't operate well as motors at very low rpm. In this case motor 24 would be used to start up since it has very high torque and efficiency at very low rpm.

### Reverse Gear

With the valve settings the same as in 1^{st} (above) except valve 13 or 19 change to the flow reversing position, the transmission would now be in the lowest reverse gear.

### Cruising Gear

In this case valves 29, 30, 31, & 39 are all in the same position as shown for pump/motor 6. In other words, the fluid is allowed to circulate within each pump/motor in effect, deselecting them.

Power is transmitted directly from the input shaft 1 to output shaft 26 by means of a selectable one-way clutch in effect providing an all-mechanical by-pass of the hydraulic transmission. The one-way clutch would be selected when the input shaft is rotating the same speed of the output shaft or slightly slower. The relative rotational speeds are measured by transducers 11 & 27. When a certain increased level of torque is called for in cruise mode, the one-way clutch will be deselected and the transmission put into hydraulic mode.

### Hydraulic Regenerative Braking (Continuously Variable)

In this case pump/motors 29, 30, & 31 can be individually selected to serve as pumps driven by the wheels of the vehicle to pump fluid from the reservoir 34 into the accumulator 15 thereby storing the braking energy of the vehicle for future use.

Valve 19 would be in the reversing position and valve 17 closed thereby directing the pumped fluid from the reservoir 34 into the accumulator 15.

To provide for continuously variable hydraulic braking, valves 16 & 17 would be closed so the pumped fluid would be diverted thru valve 38 and variable flow restricting valve 5 and valves 13 & 14 to the accumulator. The degree of braking can now be controlled by varying the degree of closure of valve 5. As valve 5 closes, it will divert the fluid thru pump/motor 6 causing it to turn shaft 7 and drive pump/motor 8 as a pump to add to the amount of fluid being pumped into the accumulator there by increasing the braking torque in a continuously variable manner. This in combination with various selections of output pump/motors will result in a wide continuous range of braking torque. Valve 36 would be open and the dog clutch 3 disengaged in this case.

Initial acceleration (Powered by Accumulator only)

Dog clutch 3 is disengaged. Valve 13 is in the flow reversing position. Valve 19 is as shown in FIG. 2. Initially valve 16 is closed and valve 14 is opened enough to allow the one way clutch 32 to engage. Speed of engagement is controlled by sensing the rpm at transducers 11 & 27. Pump/motors 6, 8, 21, 23 & 24 are individually selected by valves 29, 30, 31, 39, & 41 depending on how much acceleration is called for by the operator. The amount of acceleration can be further adjusted by varying the amount valves 14, & 17 are opened.

### Emergency Brake

By progressively closing valve 30A with valve 31 in the position shown, pump/motor 21 will cause the transmission to act as a vehicle brake. All pump/motors on shaft 25 can be simultaneously or separately used in this manner. This can also be done on the input shaft.

### Shifting Shock Reduction

When input pump/motors and/or output pump/motors are selected or deselected during operation, a pressure wave in the hydraulic fluid is created. This can result in harshness or even damage to the transmission. This can be avoided in the following manner. The acceleration or deceleration called for by the vehicle operator is compared to the actual torque in shaft 28. The error signal created by this comparison and the pressure measured in the accumulator 15 can be used to adjust valves 14 & 17 such as to change the torque in shaft 28 towards the level called for by the operator. One strategy would be to open valves 14 and/or 17 simultaneously with the shifting instruction (to immediately absorb any pressure spikes) and immediately thereafter adjust valves 14 and/or 17 in the direction to achieve the called for torque. In this manner, the transmission can be shifted as fast as the valves will allow without causing excessive shock to the system or NVH.

FIG. 3 is a cross-section representation of one mechanical arrangement for this transmission. 54 is the dog clutch, 55 the reduction gear, 56, 57, 59, & 60 are the pump/motors and 58 is the one-way clutch. Pump/motors are permanently fixed to cylindrical shaft 63. 61 is the conventional mechanical transmission. All components are mounted on the same axis resulting in a compact configuration.

It is preferable to select displacement values of the pump/motors and the input gear reduction such that at one setting the speed of the input shaft 12 is the same as output shaft 25, thus facilitating the engagement of clutch 32.

The addition of a conventional automatic or manual two speed gear box 26 on the output shaft 25 will double the available fixed transfer ratios. More than two speeds will increase the number of ratios further.

The addition of an electric motor/generator between the transmission and the dog clutch 3 would allow the transmission to be used for a combination hydraulic and plug-in electric hybrid vehicle. The use of the hydraulic accumulator etc. would allow for a much smaller electric motor generator and battery than would otherwise be required for a straight plug-in electric hybrid vehicle.

While modes have been described for carrying out the invention, those familiar with the art to which this invention relates will recognize various alternative designs and embodiments for practicing the invention within the scope of the appended claims.

When the word pump/motor is used in the following claims, it will mean a fixed-displacement hydraulic device that can function either as a hydraulic pump or a hydraulic motor.

What is claimed is:

1. A hydraulic transmission comprising:
two or more pump/motors mounted on a single shaft (designated as the input pump/motors);
one or more pump/motors mounted on a single shaft (designated as the output pump/motors); and
a set of hydraulic lines and valves interconnecting said input and output pump/motors in such a manner that one or more of the input pump/motors can be connected to one or more of the output pump/motors and in such a manner that the fluid in those pump/motors not interconnected will be caused to re-circulate within each pump/motor separately.

2. The transmission of claim 1 wherein aforementioned valves are mounted physically as close as practical to their associated pump/motor so as to cause the fluid path when in the re-circulating configuration to be as short as practical and to be configured for minimal resistance to the re-circulating flow.

3. The transmission of claim 1 wherein the input shaft is connected to the output shaft by means of a selectable one-way clutch for the purpose of bypassing the hydraulic transmission and has the means to be de-selected when an increase in torque is called for by the vehicle operator or at other times.

4. The transmission of claim 1 wherein a speed reduction gear is located between the input shaft and the input pump/motors.

5. The transmission of claim 4 wherein the reduction gear is of the planetary type and is attached to a cylindrical shaft that is placed concentrically around the input shaft such that the input shaft can extend through it and the reduction gear to the one-way clutch for the purpose of reducing the physical size of the transmission.

6. The transmission of claim 1 where an additional pump/motor optimized for high motor torque at low rpm to assist in start-up is mounted on either the input shaft and/or the output shaft and connected hydraulically in a manner similar to the other pump/motors.

7. The transmission on claim 1 with the addition of an accumulator and a reservoir connected in such a manner as to allow a controllable portion of the fluid pumped by the input pump/motors to flow into the accumulator for the purpose of decreasing the output torque in a controllable manner to allow for a soft start of the vehicle at a relatively high rpm of the motor to eliminate the need of a conventional torque converter.

8. The transmission of claim 7, wherein the fluid that is caused to flow into or out of the accumulator is controlled as a means to continuously adjust the transfer ratio of the transmission.

9. The transmission of claim 7, wherein the flow in and out of the accumulator during the de-selection or selection of one or any of the pump/motors is controlled by a measurement of the torque in the output of the transmission so as to cause the accumulator to absorb the hydraulic shock resulting from rapidly changing the transfer ratio of the transmission.

10. The transmission of claim 7 with a one-way clutch between the input and output shafts wherein the hydraulic connections allow both the input and output pump/motors to be driven as motors with fluid from the accumulator in a direction to contribute to the acceleration of the vehicle.

11. The transmission of claim 7 wherein the hydraulic valves and flow paths are such that during braking, the output pump/motors pump fluid into the accumulator in such a way that a variable flow control valve in the re-circulating path of one of the unselected input pump/motors will drive one or more of the other input pump/motors causing them to increase the flow into the accumulator in a controllable manner thereby allowing a continuously variable braking torque to be created.

12. The transmission of claim 1 wherein a conventional automatic or manual transmission is mounted on the output shaft near the exit point of the transmission in such a manner as to change the transfer ratios of the overall transmission.

13. The transmission of claim 1 wherein an electric motor/generator is mounted on the input shaft of the transmission at the entry point in such a manner as to allow it to drive the transmission as a motor and be driven by the transmission as a generator.

14. The addition of a controllable flow restriction in the re-circulating path of one or more of a deselected pump/motors either in the input and/or the output to act as a variable brake.

15. The selection of the displacement of the input and output pump/motors and the ratio of the reduction gear in the transmission of claim 4, wherein the resulting speed of the input and output shafts can be made the same for the purpose low shock engagement of the one-way clutch.

16. The transmission of claim 7 wherein a safety valve will cause fluid to flow from the accumulator to the reservoir in the event of a crash and said valve will be opened by a signal derived from an omni-directional accelerometer.
